(19) United States
(12) Patent Application Publication
(10) Pub. No.: US 2012/0155558 A1
(43) Pub. Date: Jun. 21, 2012

(54) INTEGRATING DEVICE OF WIRELESS CHARGING AND WIRELESS NETWORK FUNCTION

(76) Inventor: Nai-Chien CHANG, Linkou Township (TW)

(21) Appl. No.: 12/973,048

(22) Filed: Dec. 20, 2010

(51) Int. Cl. H04B 3/00

(52) U.S. Cl. 375/257

(57) ABSTRACT

An integrating device of wireless charging and wireless network function includes a power transforming module, a wireless power transmitting module and a wireless network communication module therein. The power transforming module is electrically connected to an external power source to receive and transform AC power into DC power, whereby the power transforming module supplies the DC power to the wireless power transmitting module and the wireless network communication module as working power simultaneously. The wireless power transmitting module receives the DC power to convert and generate a power signal, and the generated power signal is wirelessly transmitted to an outer electric device.

The wireless network communication module wirelessly transmits a network signal with the electric device, whereby the wireless network communication module provides wireless network function for the electric device.

### BACKGROUND OF THE INVENTION

1. Field of the Invention

The invention generally relates to wireless device, in particular, the present invention relates to a device integrated wireless charging and wireless network function.

2. Description of Prior Art

Following the progress step of technology, human being's life comes more convenient day by day. There are a plurality of types of electric devices, which can be used today, and accompanying with the development of wireless technology, electrical industrial now advanced to another grade.

Electric device such as a computer usually needs to configure with a lot of lines, for example, power line, data transmitting line, audio line and cable line, to receive and transmit electric power, sound, digital data, etc. However, more electric devices and lines are used, more inconveniences come after. Beside the inconvenience of arrangement of the lines, a collection of the lines also has a possibility of causing accidents such as an electrical fire or an explosion.

The electrical industrial is now developed toward the wireless technologies, for example, wireless charging technology, wireless network technology, wireless microphone technology, radio frequency (RF) technology, etc. When those wireless technologies above become mature and popular, it can not only resolve the problem of arranging the lines, but also reduce the cost of producing the electric devices by reducing the usage of the lines.

For example, the wireless network technology usually shares resource of cable network or wide area network (WAN) through a wireless access point (AP). If a computer has a wireless network card therein, the computer can then wirelessly connect with the wireless AP via the wireless network card. Moreover, the wireless AP physically connects to a modem to connect to the cable network via a cable line, whereby the resource of cable network can be shared with a plurality of computers which is wirelessly connected with the wireless AP.

For another example, traditional wireless charging technology receives an external electric power by a wireless charging device, and the wireless charging device generates a predetermined electromagnetic field when an external current flows through an internal circuit of the wireless charging device. When an electric device which requires charging approaches the wireless charging device, the electric device inducts the electromagnetic field and generates an induction voltage via a circuit therein. Therefore, the electric device can then proceed to charge by the induction voltage.

For another wireless charging device, it has an AC/DC converter, a frequency producer and an amplifier therein. The AC/DC converter receives AC power to transform the AC power into DC power, the frequency producer receives the transformed DC power to convert and generate a signal corresponding to a predetermined frequency, and the signal is transmitted externally to the electric device after being amplified by the amplifier. The wireless charging device here wirelessly transmits electric power to the electric device via transmitting the signal which complies with radio frequency (RF) protocol, and the electric device receives the RF signal to reconvert the RF signal into DC power as working power or charging power thereof.

However, any kind of wireless technologies should provide at least one device which is implemented to support and execute functions of the wireless technology (such as the wireless AP and the wireless charging device). Moreover, all devices are inevitable to configure with at least one power line to receive external electric power. If an amount of the devices is increased, then an amount of the power lines is also increased accompanying with the device.

Therefore, the possibility of accidents mentioned above would not be avoided and overcame.

### SUMMARY OF THE INVENTION

The objective of the present invention is to provide an integrating device of wireless charging and wireless network function in order to supply wireless charging function and wireless network function simultaneously by a sole integrating device.

In order to achieve the above objective, the integrating device of the present invention mainly includes a power transforming module, a wireless power transmitting module and a wireless network communication module therein. The power transforming module is electrically connected to an external power source to receive and transform AC power into DC power, whereby the power transforming module supplies the DC power to the wireless power transmitting module and the wireless network communication module as working power simultaneously. The wireless power transmitting module receives the DC power to convert and generate a power signal, and the generated power signal is wirelessly transmitted to an external electric device. The wireless network communication module wirelessly transmits a network signal with the electric device, whereby the wireless network communication module provides wireless network function for the electric device.

Compare to prior art, the present invention has advantages such as the modules in the integrating device share the same power source, the integrating device needs only one power line for connecting externally. Therefore, it is more convenient for user to arrange lines.

Further, modules except the wireless power transmitting module can wirelessly receive electric power from the wireless power transmitting module, without actually connecting with the power source. Therefore, the configuration space in a case of the integrating device can be saved.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of a first embodiment according to the present invention;

FIG. 2 is a block diagram of a first embodiment according to the present invention;

FIG. 3 is a block diagram of a second embodiment according to the present invention;

FIG. 4 is a schematic diagram of a second embodiment according to the present invention;

FIG. 5 is a block diagram of a third embodiment according to the present invention;

FIG. 6 is a block diagram of a forth embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

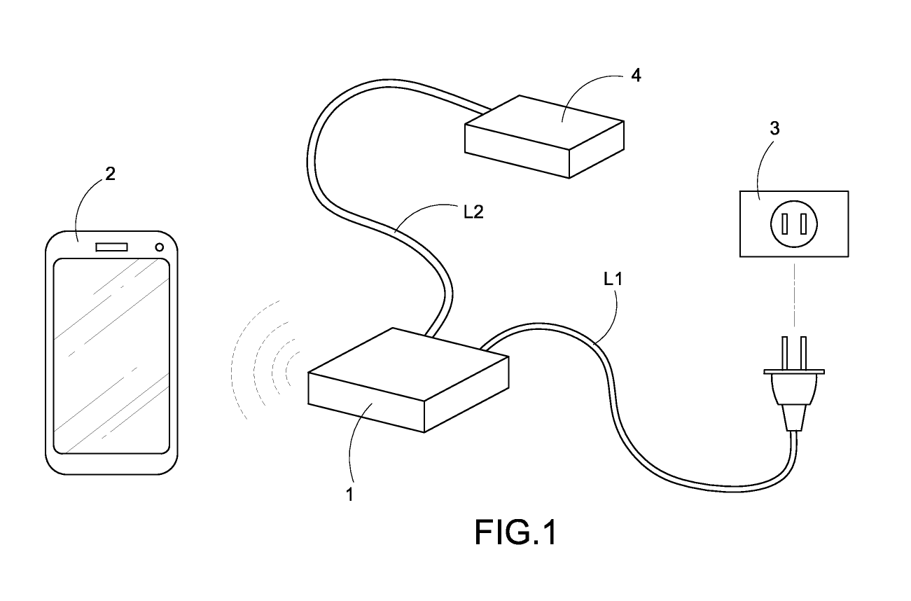

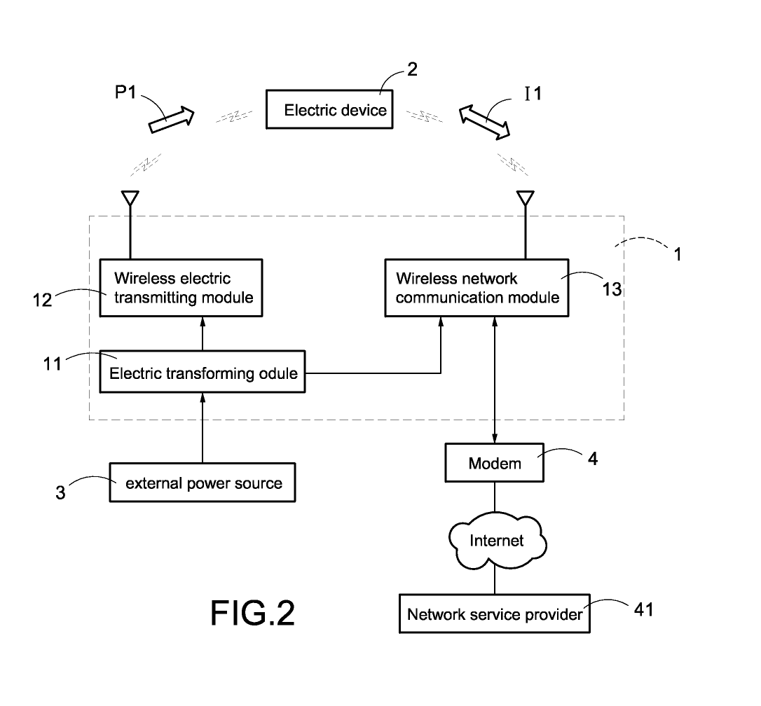

FIG. 1 is a schematic diagram of a first embodiment according to the present invention, and FIG. 2 is a block diagram of a first embodiment according to the present invention. The integrating device of wireless charging and wireless network function (called the integrating device 1 thereinafter) of the present invention is in communication with an external electric device 2 wirelessly, thereby the integrating device 1 provides electric power and wireless network function to the electric device 2. The integrating device 1 includes a power line L1 and a cable line L2 thereon, the integrating device 1 connects to an external power source 3 via the power line L1, and connects to a modem 4 externally via the cable line L2.

The integrating device 1 includes a power transforming module 11, a wireless power transmitting module 12 (called power transmitting module 12 thereinafter), and a wireless network communication module 13 (called network communication module 13 thereinafter) therein. The power transforming module 11 electrically connects to the external power source 3 to receive alternating current (AC) power transmitted from the external power source 3 so as to transform the AC power into direct current (DC) power via the power line L1.

The power transmitting module 12 electrically connects to the power transforming module 11 to receive the transformed DC power. The power transmitting module 12 then generates a first power signal P1 by converting the received DC power to transmit the generated first power signal P1 to the electric device 2, such that the power transmitting module 12 can provide the electric device 2 working power or charging power via the first power signal P1.

Moreover, the wireless charging technology is a prior art technology and has many kinds of embodiments, not intended to limit the scope of the present invention. For example, the power transmitting module 12 can receive the DC power to convert and generate a predetermined radio frequency (RF) electric wave which is complied with RF protocol, and wirelessly transmit the RF electric wave to the electric device 2. Therefore, the electric device 2 can receive the RF electric wave to reconvert the received RF electric wave into DC power via a RF reconverting circuit therein, and the electric device 2 can then proceed to charge by the reconverted DC power.

For another example, the power transmitting module 12 can also receive the DC power to generate a predetermined electromagnetic field. When the electric device 2 approaches the integrating device 1, the electric device 2 inducts the electromagnetic field and then generates an induction voltage via a circuit therein. Therefore, the electric device 2 can reconvert the induction voltage into DC power and proceed to charge by the reconverted DC power.

The network communication module 13 electrically connects to the power transforming module 11 and receives the transformed DC power transmitted from the power transforming module 11. The network communication module 13 is in communication with the electric device 12 and wirelessly transmits a network signal I1 with the electric device 12. Therefore, the network communication module 13 can provides wireless network function for the electric device 2.

In this embodiment of the present invention, the network communication module 13 is a wireless access point (AP) which is complied with wireless fidelity (Wi-Fi) communication protocol, and the network communication module 13 physically connects to the modem 4 externally via, but not limited to, the cable line L2. The modem 4 is in communication with a network service provider 41 via internet, and the modem 4 and the network service provider 41 are prior art technologies, and the description thereof is omitted here for brevity.

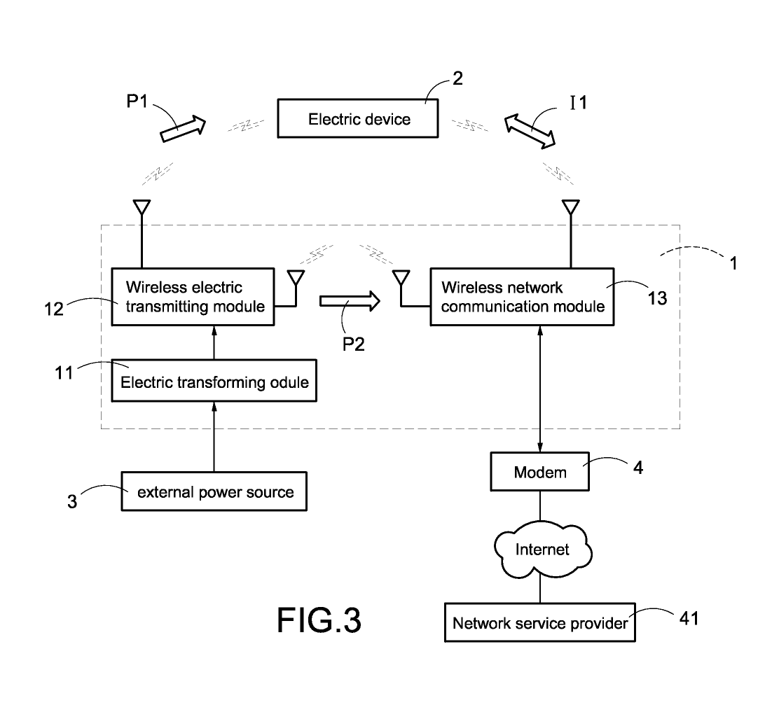

FIG. 3 is a block diagram of a second embodiment according to the present invention.

In the present invention, the power transmitting module 12 is used to wirelessly transmitting electric power externally via generating and transmitting power signals, whereby the network communication module 13 can receive the power signal transmitted from the power transmitting module 12 instead of substantially connecting to the power transforming module 11 to receive the DC power.

The network communication module 13 includes a reconverting circuit (not shown) as the same of the electric device 2 therein. The network communication module 13 wirelessly receives a second power signal P2 generated and transmitted from the power transmitting module 12, and the received second power signal P2 is reconverted into DC power for being working power via the reconverting circuit of the network communication module 13.

Therefore, the configuration space in the integrating device 1 can be saved and simplified via reducing a line which is used to connect the network communication module 13 with the power transforming module 11, such that more and more wireless modules could be configured and integrated in the integrating device 1.

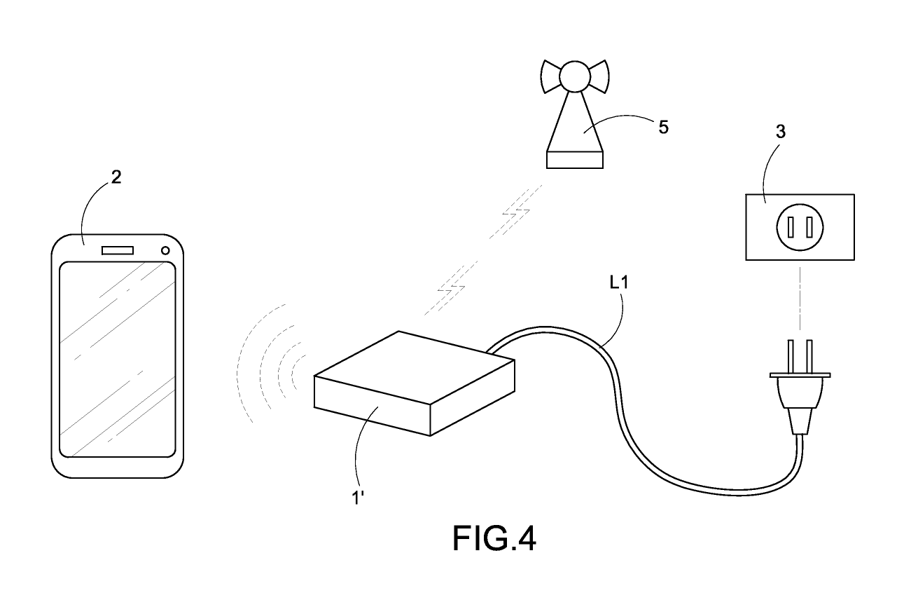

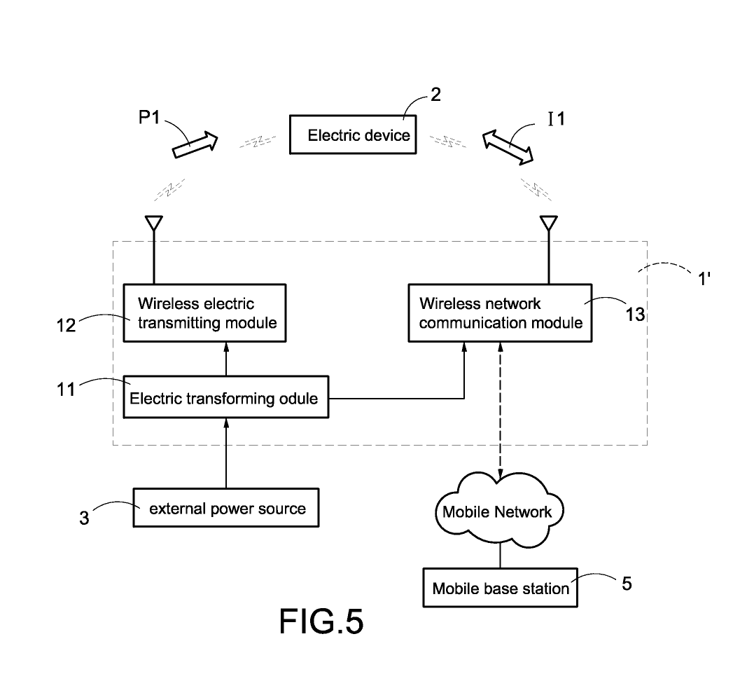

FIG. 4 is a schematic diagram of a second embodiment according to the present invention, and the FIG. 5 is a block diagram of a third embodiment according to the present invention. In this embodiment, an integrating device 1′ only needs the power line L1 to connect with the external power source 3 and needs not the cable line L2. The electric device 2 which is in communication with the integrating device 1′ needs not to connect any substantial lines, whereby the usage of the present invention is more convenient for user.

Without connecting the cable line L2, the network communication module 13 of the integrating device 1′ is a wireless network signal converter which implements to convert third generation (3G) communication protocol into Wi-Fi communication protocol in this embodiment. The network communication module 13 of the integrating device 1′ wirelessly connects to a mobile base station 5 to receive 3G network signal, the network communication module 13 further converts the received 3G network signal into the network signal I1 which is complied with Wi-Fi communication protocol, and wirelessly transmits the converted network signal I1 with the electric device 2 for providing wireless network function.

In this embodiment of FIG. 5, the power transforming module 11 electrically connects to the external power source 3 via the power line L1, the power transmitting module 12 electrically connects to the power transforming module 11 to receive the DC power, and converts the received DC power to generate the first power signal P1 to wirelessly transmit to the electric device 2. The network communication module 13 also electrically connects to the power transforming module 11 to receive the DC power as working power.

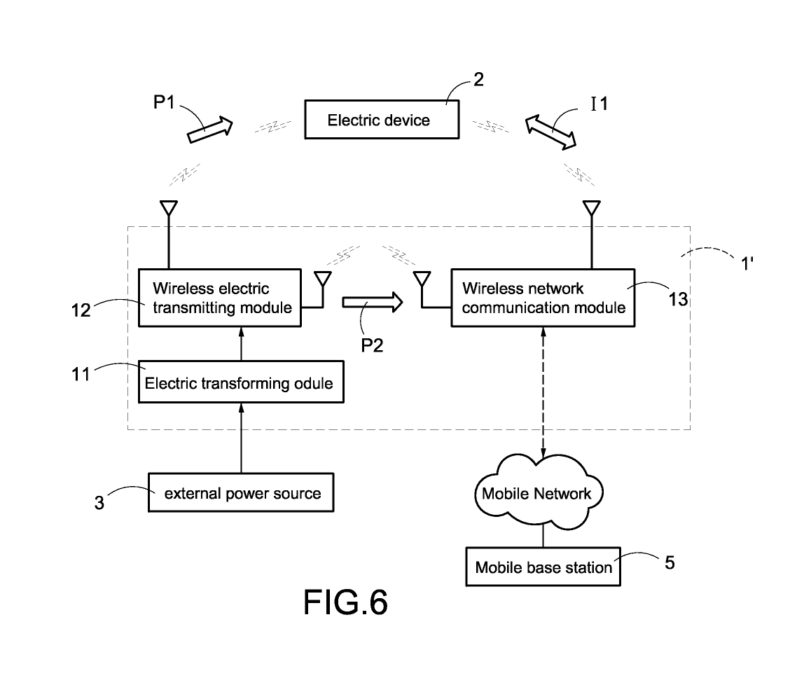

FIG. 6 is a block diagram of a forth embodiment according to the present invention.

In this embodiment, the network communication module 13 of the integrating device 1′ includes a reconverting circuit (not shown) which is the same as that of the electric device 2 therein. The network communication module 13 wirelessly receives the second power signal P2 generated and transmitted from the power transmitting module 12, and the received second power signal P2 is reconverted into DC power for being working power via the reconverting circuit of the network communication module 13. Therefore, the network communication module 13 needs not to substantially connected to the power transforming module 11 to receive the DC power, and the configuration space in the integrating device 1′ can then be saved and simplified as the same showing in that embodiment of FIG. 3.

It should be mentioned that, beside the first power signal P1 and the second power signal P2, more and more power signals could be generated and transmitted by the power transmitting module 12 to be working power or charging power for internal modules or external devices. Therefore, a power line is unnecessary for any outer electric devices and wireless modules in the integrating device 1 and 1′, excepting the integrating device 1 and 1′ themselves. The integrating device 1 needs the power line L1 and the cable line L2 to connect externally, and the integrating device 1′ needs only the power line L1 to connect externally, whereby the inconvenience of the arrangement of lines is then resolved by the present invention.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. An integrating device of wireless charging and wireless network function providing electric power and wireless network function to an external electric device, the integrating device comprises:
a power transforming module electrically connected to an external power source via a power line, the power transforming module receiving alternating current (AC) power from the external power source to transform the AC power into direct current (DC) power;
a wireless power transmitting module electrically connected to the power transforming module to receive the DC power transformed and transmitted from the power transforming module, the wireless power transmitting module converting the received DC power to generate a first electric signal to wirelessly transmit to the electric device; and
a wireless network communication module electrically connected to the power transforming module to receive the DC power transformed and transmitted from the power transforming module, the wireless network communication module being in communication with the electric device and transmitting a network signal with the electric device for providing wireless network function to the electric device.

2. The integrating device in claim 1, wherein the wireless network communication module is a wireless access point (AP) which complies with wireless fidelity (Wi-Fi) communication protocol.

3. The integrating device in claim 2, wherein the wireless network communication module physically connects to a modem externally via a cable line.

4. The integrating device in claim 1, wherein the wireless network communication module is a wireless network signal converter which implements to convert third generation (3G) communication protocol into Wi-Fi communication protocol.

5. The integrating device in claim 4, wherein the wireless network communication module wirelessly connects to a mobile base station to receive 3G network signal externally.

6. An integrating device of wireless charging and wireless network function providing electric power and wireless network function to an outer electric device, the integrating device comprises:
a power transforming module electrically connected to an external power source via a power line, the power transforming module receiving AC power from the external power source to transform into DC power;
a wireless power transmitting module electrically connected to the power transforming module to receive the DC power transformed and transmitted from the power transforming module, the wireless power transmitting module converting the received DC power to generate a first electric signal and a second electric signal, wherein the first electric signal is wirelessly transmitted to the electric device; and
a wireless network communication module wirelessly receiving the second electric signal generated and transmitted from the wireless power transmitting module, the wireless network communication module being is communication with the electric device and transmitting a network signal with the electric device for providing wireless network function to the electric device;
wherein, the wireless network communication module reconverts the received second electric signal into DC power as working power.

7. The integrating device in claim 6, wherein the wireless network communication module is a wireless AP which complies with Wi-Fi communication protocol.

8. The integrating device in claim 7, wherein the wireless network communication module physically connects to a modem externally via a cable line.

9. The integrating device in claim 6, wherein the wireless network communication module is a wireless network signal converter which implements to convert 3 G communication protocol into Wi-Fi communication protocol.

10. The integrating device in claim 9, wherein the wireless network communication module wirelessly connects to a mobile base station to receive 3G network signal externally.
